(19) United States
(12) Patent Application Publication
(10) Pub. No.: US 2026/0160684 A1
(43) Pub. Date: Jun. 11, 2026

(54) METALENS-BASED DEVICE FOR DETECTION OF SINGLE MOLECULE

(71) Applicants: RESEARCH & BUSINESS FOUNDATION SUNGKYUNKWAN UNIVERSITY, Suwon-si (KR); POSTECH Research and Business Development Foundation, Pohang-si (KR)

(72) Inventors: INKI KIM, Suwon-si (KR); Junsuk Rho, Pohang-si (KR); ALEKSANDR BARULIN, Suwon-si (KR); Yeseul Kim, Pohang-si (KR); DONGKYO OH, Pohang-si (KR)

(21) Appl. No.: 19/181,582

(22) Filed: Apr. 17, 2025

(30) Foreign Application Priority Data
Apr. 18, 2024 (KR) 10-2024-0052382

(51) Int. Cl. G01N 21/64; G01N 15/00

(52) U.S. Cl. CPC G01N 21/6428; G01N 15/00; G01N 2021/6439

(57) ABSTRACT

Disclosed are a metalens operable at dual wavelengths and a molecular detection device comprising same. The metalens, having a high numerical aperture, high focusing efficiency, and dual-wavelength operability, enables fluorescence correlation spectroscopy (FCS) using a single Alexa 647 molecule within the focal volume. In addition, the metalens allows for real-time monitoring of individual fluorescent nanoparticle transitions and identification of hydrodynamic diameters ranging from a few nanometers to several hundred nanometers. This enhancement in sensitivity may be applied to extend metalens technology to ultra-compact single-molecule sensors.

### CROSS-REFERENCE TO RELATED APPLICATION(S)

This application is based on and claims priority under 35 U.S.C. 119 to Korean Patent Application No. 10-2024-0052382, filed on Apr. 18, 2024, in the Korean Intellectual Property Office, the disclosure of which is herein incorporated by reference in its entirety.

### BACKGROUND OF THE INVENTION

### 1. Field of the Invention

The present disclosure was supported by the Ministry of Science and ICT of the Republic of Korea under Project No. 1711198556. The research management agency for the above project is the National Research Foundation of Korea (NRF), the project title is “Development of Convergent Frontier Technology for Brain Science”, the research task title is “Development of a Spatiotemporally Integrated Analysis Pipeline (iTRAP) for Precision Medicine Based on Brain Disease Organoids”, the leading institution is Sungkyunkwan University Research & Business Foundation, and the research period is from Jul. 1, 2023 to Dec. 31, 2023.

The present disclosure was also supported by the Ministry of Science and ICT of the Republic of Korea under Project No. 1711192661. The research management agency for the above project is the National Research Foundation of Korea (NRF), the project title is “STEAM Research”, the research task title is “Development of an Optical Platform for Commercialization of Smart Anti-Counterfeiting Technology”, the leading institution is Pohang University of Science and Technology (POSTECH), and the research period is from Mar. 1, 2023 to Dec. 31, 2023.

This patent application claims priority to Korean Patent Application No. 10-2024-0052382, filed on Apr. 18, 2024, with the Korean Intellectual Property Office, the disclosure of which is incorporated herein by reference.

The present disclosure relates to a metalens operable at dual wavelengths and a molecular detection device including same.

### 2. Description of the Prior Art

Single-molecule sensing technologies are critically important in biosensing, single-molecule chemistry, molecular dynamics, DNA sequencing, and proteomics. Ultrasensitive fluorescence techniques can probe individual processes that would require synchronization in ensemble measurements. In particular, fluorescence correlation spectroscopy (FCS) allows for the collection of dynamic data from recurring single-molecule events. Although single-molecule fluorescence techniques have advanced over the past few decades, the required equipment is complex and expensive, and typically includes bulky objective lenses in the market that make certain applications restrictive such as point-of-care diagnostic settings and environmental monitoring. Previously, miniaturized smartphone-based microscopes enabled the detection of single nanoparticles using low numerical aperture (NA) optics, and when integrated with addressable nanoantenna platforms, can achieve single-molecule-level sensitivity. Alternatively, portable lens-free holographic imaging platforms could provide single nanoparticle observation above 40 nm. In contrast, dielectric metalenses allow for unprecedented electromagnetic field tailoring to focus light close to the diffraction limit with high NA, whereas their micrometer-thick arrangement of meta-atoms is suitable for miniaturized imaging systems. Research on metalenses has progressed toward chromatic aberration correction at two or three wavelengths or within a broad bandwidth. The compactness and focusing performance make the metalens a suitable candidate to further miniaturize single molecule detection systems toward truly portable devices. Dielectric metasurfaces operating as phase and polarization masks in the microscope Fourier plane are able to get rid of localization biases in single-molecule imaging. However, achieving fluorescence sensitivity at the single-molecule level under epi-fluorescence operation requires that the lens simultaneously possess high focusing efficiency, high NA, and achromatic focus. Finding a trade-off between these functionalities in a single metalens device poses a fundamental challenge. In contrast, near-unity NA metalenses have previously been used to detect the emission of individual diamond nitrogen-vacancy (NV) centers.

However, these metalenses operate only as single-wavelength collection lenses, limiting their practical miniaturization and applicability as portable devices for epi-fluorescence detection. Moreover, NV centers are typically brighter than conventional organic fluorescent molecules by two or three orders of magnitude and yield extraordinary photostability, drastically relaxing the requirements for metalens performance. Therefore, there is a need to develop a metalens operable at dual wavelengths, capable of single-molecule imaging.

### SUMMARY OF THE INVENTION

Leading to the present disclosure, intensive and thorough research conducted by the present inventors with the aim of developing an ultra-compact metalens capable of replacing the conventional objective lens used in molecular detection devices resulted in the finding that when using a metalens in which nanostructures having a square pillar shape are arranged at regular intervals, the conventional objective lens can be replaced.

Accordingly, an aspect of the present disclosure is to provide a metalens including a substrate and a plurality of nanostructures having a square pillar shape arranged at regular intervals along circumferential and radial directions on the substrate.

Another aspect of the present disclosure is to provide a detection device for a fluorescent substance or a molecule conjugated with a fluorescent substance, the detection device including the metalens.

Still another aspect of the present disclosure is to provide a method for detecting a molecule, the method including the steps of introducing excitation light through a metalens to irradiate a sample; and collecting fluorescence emitted from the sample through the metalens.

Other objects and advantages of the present disclosure will be more clearly understood from the following detailed description of the invention, the claims, and the drawings.

Provided according to an aspect of the present disclosure is a metalens including: a substrate; and a plurality of nanostructures having a square pillar shape, arranged at regular intervals along circumferential and radial directions on the substrate.

Intensive and thorough research conducted by the present inventors with the aim of developing an ultra-compact metalens to replace the conventional objective lens used in molecular detection devices culminated in the discovery that a metalens in which nanostructures having a square pillar shape are arranged at regular intervals can replace the conventional objective lens.

As used herein, the term “metasurface” refers to an artificially designed, extremely thin surface, which is typically composed of nanoscale structures. These nanostructures manipulate electromagnetic waves-particularly light-so as to control optical properties such as refraction, reflection, polarization, and phase shift. Metasurfaces are significantly smaller than traditional optical elements and are capable of manipulating light more efficiently, thereby enabling applications in various fields including optics, sensing, communications, and imaging. Metasurfaces may also be applied to lenses that adjust focal points according to optical properties (e.g., amplitude, phase) while transmitting light, and such lenses are referred to as metalenses.

Herein, the center of the circle defining the radial and circumferential directions corresponds to the center of the metalens. The substrate of the metalens may be made of a material selected from glass (e.g., fused silica, BK7, etc.), quartz, polymers (e.g., PMMA, SU-8, etc.), and plastics, and may also be a semiconductor substrate.

In an embodiment of the present disclosure, the metalens may be formed such that nanostructures made of hydrogenated amorphous silicon (a-Si:H) are formed on a silicon dioxide glass substrate.

For example, when arranging nanostructures to serve as a lens exhibiting refractive power for multiple light sources of different wavelengths, an arrangement based on a Cartesian coordinate system may be limited in correcting aberrations. In determining the size or shape of the nanostructures according to their position in the present embodiment, a rule based on a polar coordinate system may be applied. Each position of the plurality of nanostructures may be represented by a coordinate (r, φ) where r is the distance in the radial direction on the plane parallel to the metalens from the origin (i.e., the center of the metalens), and φ is the rotation angle from a reference line on the plane around the axis normal to the plane at the origin.

In an embodiment of the present disclosure, the metalens may be fabricated using a lithography technique that employs electron or photon beams. In the lithography process for fabricating the metalens, a focused beam may be scanned over the surface of the substrate to generate a pattern corresponding to the desired metasurface structure. In some cases, the surface of the substrate may be coated with a resist material that changes its characteristics upon exposure to beam energy. Depending on the type of resist material used, either the exposed or unexposed portion of the resist material may be selectively removed, while the remaining portion stays on the substrate surface. When the resist material is selectively removed, the substrate may be exposed and etched (e.g., by wet etching, dry etching, or reactive ion etching (RIE)) to remove a portion of the substrate material. In some cases, the etching process may form geometric features of the metasurface on the surface of the substrate to fabricate the metalens. In some cases, because the geometric features of the metasurface must be patterned onto the resist material by directing the focused beam at it, the fabrication process may be time-consuming and expensive.

Systems, devices, processes (also referred to as methods), and computer-readable media (collectively referred to as “systems and techniques”) for fabricating metalenses and optical systems comprising metalenses in a scalable manner are described in the present specification. For example, semiconductor fabrication technologies are used to simultaneously create multiple devices (e.g., microprocessors, application-specific integrated circuits, etc.) on a single silicon wafer. In contrast to the lithography techniques described above, the features formed on the surface of a silicon wafer are not individually drawn.

Instead, the features of the device (or a negative representation thereof) may be patterned onto a mask. The features of a single device may be repeated in an array to fill a region (or a portion thereof) on the surface of a silicon wafer comprising multiple devices. Through a single exposure to light, the pattern on the mask may be transferred onto a photosensitive resist material (photoresist). In semiconductor manufacturing, multiple masks may be used to fabricate various features of a device, such as metal layers, transistors, passivation layers, and mechanical structures. Accordingly, it would be advantageous if the photolithography processes used in semiconductor fabrication could also be applied to the fabrication of metalenses.

In some embodiments, silicon materials used in many semiconductor manufacturing applications are transparent to certain wavelengths of light. In some cases, optical applications may detect light at wavelengths to which silicon is transparent. Therefore, silicon may be a suitable substrate material for fabricating metalenses for image sensing applications, wherein the silicon is transparent to the wavelengths of light being detected. For example, such applications may utilize short-wave infrared (SWIR) light. In some cases, SWIR-sensitive image sensors may be fabricated using semiconductor manufacturing techniques. For instance, SWIR-sensitive imagers may be fabricated on silicon wafers using germanium-silicon (GeSi)-based complementary metal-oxide-semiconductor (CMOS) technology. In some cases, the above-described semiconductor manufacturing techniques may be used to fabricate metalenses on silicon wafers.

In certain optical applications, silicon may not be a suitable substrate for metalens fabrication, as the wavelengths of light relevant to the application may not pass through silicon. For example, silicon is opaque at visible wavelengths, and many optical applications detect light in the visible range. In such cases, a material that is transparent in the visible spectrum may be a suitable substrate for metalens fabrication. In one exemplary example, metalenses may be fabricated on glass substrates. In some cases, nanoimprint lithography techniques may be used to fabricate metalenses on glass substrates.

In one embodiment of the present disclosure, the method of fabricating the metalens includes forming nanostructures on a substrate for the metalens, which may be carried out using an electron beam lithography (E-beam lithography) process. As one example of the method for fabricating the metalens of the present disclosure, a 600 nm-thick a-Si:H layer is first deposited using plasma-enhanced chemical vapor deposition (PECVD), and then an electron beam is focused onto a coated positive-tone photoresist, PMMA, to pattern the desired nanostructure shapes. Next, a chromium layer is deposited to be used as an etching mask. After performing a dry etching process, the remaining etching mask is removed, thereby completing the nanostructures of the metalens.

In one embodiment of the present disclosure, the diameter of the metalens may be 100 to 1000 μm. For example, the diameter of the metalens may be 100 to 1000 μm, 100 to 900 μm, 100 to 800 μm, 100 to 700 μm, 100 to 600 μm, 100 to 500 μm, 100 to 400 μm, 100 to 300 μm, 100 to 200 μm, 200 to 1000 μm, 300 to 1000 μm, 400 to 1000 μm, 500 to 1000 μm, 600 to 1000 μm, 700 to 1000 μm, 800 to 1000 μm, 900 to 1000 μm, 200 to 900 μm, 300 to 800 μm, 400 to 700 μm, 400 to 600 μm, or 450 to 550 μm, but is not limited thereto.

In one embodiment of the present disclosure, the height of the metalens may be 100 to 1000 nm. For example, the height of the metalens may be 100 to 1000 nm, 100 to 900 nm, 100 to 800 nm, 100 to 700 nm, 100 to 600 nm, 100 to 500 nm, 100 to 400 nm, 100 to 300 nm, 100 to 200 nm, 200 to 1000 nm, 300 to 1000 nm, 400 to 1000 nm, 500 to 1000 nm, 600 to 1000 nm, 700 to 1000 nm, 800 to 1000 nm, 900 to 1000 nm, 200 to 900 nm, 300 to 800 nm, 400 to 700 nm, 400 to 600 nm, or 450 to 550 nm, but is not limited thereto. In some embodiments of the present disclosure, the height of the metalens may be used synonymously with the thickness of the metalens.

In one embodiment of the present disclosure, the numerical aperture (NA) of the metalens may be from 0.5 to 2.0. As used in the present specification, the term “numerical aperture” refers to a measure of a lens's ability to collect light and is an important parameter in microscopes and other optical instruments. The numerical aperture is calculated by the equation NA=n×sin(θ), where n is the refractive index of the medium, and θ is the maximum half-angle between the light rays passing through the lens and the optical axis of the lens.

In one embodiment of the present disclosure, the metalens may have a property of modulating the phase of light such that a first light and a second light, different from each other in wavelengths, exhibit the same phase shift when transmitted through the metalens. The difference in wavelengths between the first light and the second light may be 10 nm to 100 nm. For example, the wavelength difference between the first light and the second light may be, for instance, 10 to 100 nm, 10 to 90 nm, 10 to 80 nm, 10 to 70 nm, 10 to 60 nm, 10 to 50 nm, 10 to 40 nm, 10 to 30 nm, 10 to 20 nm, 20 to 100 nm, 30 to 100 nm, 40 to 100 nm, 50 to 100 nm, 60 to 100 nm, 70 to 100 nm, 80 to 100 nm, 90 to 100 nm, 20 to 80 nm, 30 to 70 nm, 30 to 60 nm, 30 to 50 nm, or 30 to 40 nm, but with no limitations thereto.

In one embodiment of the present disclosure, the wavelength of the first light may be 500 to 700 nm. For example, the first light may have a wavelength of 500 to 700 nm, 550 to 700 nm, 600 to 700 nm, 650 to 700 nm, 500 to 650 nm, 500 to 600 nm, 500 to 550 nm, 550 to 650 nm, or 600 to 650 nm, and more specifically, 630 to 640 nm, but is not limited thereto. The wavelength of the second light may be 530 to 730 nm. For example, the second light may have a wavelength of 530 to 730 nm, 580 to 730 nm, 630 to 730 nm, 680 to 730 nm, 530 to 680 nm, 530 to 630 nm, 530 to 580 nm, 580 to 680 nm, or 630 to 680 nm, and more specifically, 665 to 675 nm, but is not limited thereto. More specifically, the wavelength of the first light may be 635 nm, and the wavelength of the second light may be 670 nm, but is not limited thereto.

In the present specification, the expression that the phase change of light is matched after passing through the metalens means that the metalens provides the same phase shift even for light of different wavelengths, allowing the light to remain synchronized after transmission through the metalens. This characteristic is particularly important in multicolor or multi-wavelength optical applications. The term “phase shift” refers to a phenomenon in which the phase of light changes as it passes through a medium. A metalens is composed of nanostructures that can precisely control such phase shifts, thereby enabling manipulation of the propagation path of light.

In one embodiment of the present disclosure, if the metalens provides the same phase shift for both 635 nm and 670 nm wavelengths, this means that light at the two wavelengths propagates in the same manner after passing through the metalens. This allows the two wavelengths to remain synchronized after transmission through the metalens and, for example, be focused at the same focal point.

This phase manipulation capability enables metalenses to be highly useful in optical systems, and can be applied in various fields such as fluorescence labeling, imaging, and optical communication. This demonstrates that the metalens can operate effectively across multiple wavelengths, which is an important property for improving the performance of optical systems.

The structural parameters (length L, width W, and height H) of the nanostructures are determined by various factors, such as the phase effect according to the polarization state of the incident light, the target incident wavelength, the size of the metalens, and the focal length.

In one embodiment of the present disclosure, the nanostructures having a square pillar shape may have a length (L) of 80 to 300 nm, a width (W) of 80 to 300 nm, a height (H) of 100 to 1000 nm, or combinations thereof.

The length (L) of the nanostructures may be, for example, 80 to 270 nm, 80 to 240 nm, 80 to 210 nm, 80 to 180 nm, 80 to 150 nm, 80 to 120 nm, 110 to 300 nm, 140 to 300 nm, 170 to 300 nm, 200 to 300 nm, 230 to 300 nm, 260 to 300 nm, 100 to 250 nm, 100 to 200 nm, 120 to 180 nm, 140 to 160 nm, or 145 to 155 nm, but is not limited thereto.

The width (W) of the nanostructures may be, for example, 80 to 270 nm, 80 to 240 nm, 80 to 210 nm, 80 to 180 nm, 80 to 150 nm, 80 to 120 nm, 110 to 300 nm, 140 to 300 nm, 170 to 300 nm, 200 to 300 nm, 230 to 300 nm, 260 to 300 nm, 100 to 250 nm, 100 to 200 nm, 120 to 180 nm, 140 to 160 nm, or 145 to 155 nm, but is not limited thereto.

The height (H) of the nanostructures may be 100 to 1000 nm. For example, the height of the metalense may be 100 to 1000 nm, 100 to 900 nm, 100 to 800 nm, 100 to 700 nm, 100 to 600 nm, 100 to 500 nm, 100 to 400 nm, 100 to 300 nm, 100 to 200 nm, 200 to 1000 nm, 300 to 1000 nm, 400 to 1000 nm, 500 to 1000 nm, 600 to 1000 nm, 700 to 1000 nm, 800 to 1000 nm, 900 to 1000 nm, 200 to 900 nm, 300 to 800 nm, 400 to 700 nm, 400 to 600 nm, or 450 to 550 nm, but is not limited thereto.

In one embodiment of the present disclosure, the nanostructures may be arranged at intervals of 100 to 500 nm. The interval of the nanostructures refers to the distance between the centers of nearest neighboring nanostructures and may be, for example, 100 to 500 nm, 100 to 450 nm, 100 to 400 nm, 100 to 350 nm, 100 to 320 nm, 100 to 300 nm, 100 to 250 nm, 100 to 200 nm, 100 to 150 nm, 150 to 500 nm, 200 to 500 nm, 250 to 500 nm, 300 to 500 nm, 350 to 500 nm, 400 to 500 nm, 450 to 500 nm, 250 to 450 nm, or 300 to 400 nm, but is not limited thereto.

In one embodiment of the present disclosure, the nanostructures having a square pillar shape are arranged in a single layer.

In one embodiment of the present disclosure, the material of the nanostructures is selected from the group consisting of hydrogenated amorphous silicon (a-Si:H), hydrogenated amorphous silicon nitride (a-SiNx:H), and hydrogenated amorphous silicon oxide (a-SiOx), but with no limitations thereto, and may include any material having a high refractive index at a wavelength of 600 to 800 nm. For example, it may include TiO2, ZrO2, SiO₂, and HfO2 but is not limited thereto.

When fabricating a metalens using hydrogenated amorphous silicon, deposition can be carried out at a low temperature, and the absorption in the visible region can be reduced compared to amorphous silicon (a-Si). Hydrogenated amorphous silicon (a-Si:H) offers low manufacturing cost and high efficiency, and can provide an effective metasurface in the visible spectrum.

In one embodiment of the present disclosure, the nanostructures have a refractive index (n) of 2.6 or greater when transmitting light having a wavelength of 600 to 800 nm. For example, the refractive index may be 2.6 or more, 2.8 or more, 3.0 or more, 3.2 or more, 3.5 or more, or 4.0 or more. In one embodiment of the present disclosure, the nanostructures have a refractive index (n) of 10.0 or less when transmitting light having a wavelength of 600 to 800 nm. For example, the refractive index may be 10.0 or less, 9.0 or less, 8.0 or less, 7.0 or less, 6.0 or less, or 5.0 or less. The refractive index may be, for example, in the range of 2.6 to 10.0, 2.6 to 8.0, 2.6 to 6.0, or 2.6 to 4.0. As used herein, the term “refractive index” refers to a numerical value indicating how strongly the lens material refracts light. Methods for calculating or measuring the refractive index of a lens generally depend on the refractive index of the material comprising the lens. If the refractive index of the lens material is well known-such as for common glass or plastic the value can be calculated by referencing standard values. The refractive index can also be measured using a refractometer, which determines how the light is bent when passing through the material. Other methods include measuring the change in the direction of light as it moves from one medium to another and calculating the refractive index using the ratio based on Snell's law; using a laser refractometer to measure the angle of refraction after the light passes through a sample; or using a prism to bend the light and measuring the angle of refraction to calculate the refractive index.

In one embodiment of the present disclosure, the nanostructures have an extinction coefficient (k) of 0.1 or less when transmitting light having a wavelength of 600 to 800 nm. The extinction coefficient of the nanostructures may be, for example, in the range of 0.0001 to 0.1.

As used in the present specification, the term “extinction coefficient (k)” refers to a parameter indicating the material's ability to absorb light. The extinction coefficient quantitatively describes the degree to which light of a specific wavelength is attenuated as it passes through a material, and it is represented by the imaginary part of the refractive index. It can be measured by calculating the attenuation of light by comparing the initial intensity of light entering the lens and the intensity after transmission, using a spectrophotometer. Alternatively, the extinction coefficient can be determined by measuring the transmittance of light through a sample of a specific thickness and applying the Beer-Lambert law.

In one embodiment of the present disclosure, the nanostructures have a transmittance of 50% or more when transmitting light having a wavelength of 600 to 800 nm. The transmittance may be, for example, 50 to 100%, 50 to 90%, 50 to 80%, 50 to 70%, 50 to 60%, 60 to 100%, 70 to 100%, 80 to 100%, 90 to 100%, or 60 to 90%, but is not limited thereto.

As used in the present specification, the term “transmittance” refers to the proportion of light that passes through the lens, and indicates how much light is transmitted by the lens. Transmittance is defined as the ratio of the intensity of the light that passes through the lens to that of the incident light. It can be measured by using a spectrophotometer to determine the intensity of light transmitted through the lens at a specific wavelength; using dedicated equipment designed to directly measure transmittance; or by using the Beer-Lambert law, which relates the attenuation of light passing through a material to the material's concentration and path length.

An aspect of the present disclosure provides a molecular detection device, comprising the above-described metalens and configured to detect a fluorescent material or a molecule conjugated with a fluorescent material.

The molecular detection device of the present disclosure shares the characteristics of the above-described metalens in that it utilizes a metalens, and redundant descriptions are omitted to avoid unnecessary complexity of the specification.

As used herein, the term “fluorescent material” refers to a substance that absorbs excitation light of a specific wavelength irradiated from an external source and emits fluorescence of a longer wavelength due to a change in energy state. Such fluorescent materials can be widely used in various fields including fluorescence imaging, molecular diagnostics, and biosensing.

The fluorescent material may be used in a free state or in the form of a fluorescent probe selectively bound to a specific target. For example, the fluorescent material may be conjugated with various biomolecules such as antibodies, proteins, nucleic acids, or ligands and used for detecting the presence of a target molecule or for quantitative analysis.

Examples of fluorescent materials usable in the present disclosure include natural fluorescent proteins, fluorescent materials based on organic compounds, quantum dots, or complexes thereof. The fluorescent material should exhibit a Stokes shift and preferably have high fluorescence efficiency in the wavelength range compatible with the metalens and optical system used in the present disclosure. For instance, a fluorescent material applicable to the present disclosure may exhibit a Stokes shift of 10 nm to 100 nm and preferably emit fluorescence in a broadband range of 600 nm to 800 nm.

In addition, the fluorescent material is effectively excited by excitation light incident through the metalens, and the fluorescence emitted from the fluorescent material is configured to be collected with high focusing efficiency through the optical properties of the metalens. Through this configuration, the fluorescence detection device according to the present disclosure can achieve a higher signal-to-noise ratio (SNR) and detection sensitivity compared to conventional technologies.

The molecular detection device may be a fluorescence correlation spectroscopy (FCS) device.

The fluorescent material or the molecule conjugated with a fluorescent material may include a light-emitting source, such as fluorescent dye molecule, phosphorescent dye molecule, quantum dot, or light-emitting nanoparticle. The target may also be a light-scattering particle. In addition, the target may be a molecule that does not inherently emit light but is conjugated to a light-emitting label (e.g., a fluorescent dye molecule, phosphorescent dye molecule, or quantum dot). Some labels may specifically bind to a target molecule. Therefore, the target molecule may be identified via the label. One or more labels may be bound to a single target molecule.

In one embodiment of the present disclosure, the detection device includes photodetector configured to detect light emitted from a target. In the present disclosure, the photodetector includes an optical sensor capable of at least partially absorbing incident light and outputting a signal corresponding to the light. The optical sensor may include, for example, a p-n photodiode, p-i-n photodiode, multi-junction photodiode, avalanche photodiode (APD), phototransistor, quantum-well infrared photodetector (QWIP), photoconductive optical sensor, photovoltaic optical sensor, thin-film on ASIC (TFA), metal-semiconductor-metal (MSM) photodetector, charge-coupled device (CCD), CMOS sensor, or combinations thereof.

In one embodiment of the present disclosure, the photodetector includes a control circuit for controlling the operation of the photodetector. The control circuit may include circuits for signal amplification, A/O converters, integrators, comparators, logic circuits, readout circuits, memory, microprocessors, clocks, and address components.

In one embodiment of the present disclosure, the metalens is configured as a single layer. The metalens of the present disclosure exhibits excellent focusing alignment and efficiency even as a single-layer structure, and thus does not require a multi-layer configuration, which avoids problems related to layer alignment.

Photoluminescent materials are selected based on their Stokes shift. For example, a photoluminescent material provides a Stokes shift of about 30 nm or greater. In some embodiments, the photoluminescent material is a photoluminescent dye such as anthracene, coumarin, pyrene, stilbene, porphyrin, perylene, Alq3, eosin, BODIPY dye, fluorescent dye, rhodamine, polymethine dye, DCM or derivatives thereof. In some embodiments, the photoluminescent material is a luminescent polymer such as PPV or a derivative thereof. In some embodiments, the photoluminescent material is an inorganic material such as quantum dots, alumina, or zinc oxide.

In one embodiment of the present disclosure, the molecular detection device comprising the designed metalens provides sufficient sensitivity to capture fluorescence signals and fluorescence correlation spectroscopy (FCS) correlation functions from 1.7 Alexa 647 molecules within the detection volume.

In one embodiment of the present disclosure, the fluorescent material has a Stokes shift of 10 to 100 nm. Specifically, the fluorescent material may have a Stokes shift of 30 to 50 nm. More specifically, the fluorescent material may have a Stokes shift of 35 nm.

In one embodiment of the present disclosure, the fluorescent material is excited by light having a wavelength of 630 to 640 nm and emits fluorescence having a wavelength of 665 to 675 nm.

As used herein, “excitation” of the fluorescent material refers to the process in which the fluorescent material absorbs light and transitions to a higher energy state. In this process, electrons of the fluorescent material move from the ground state to a higher energy level. The excitation process occurs by absorbing light of a specific wavelength, which is determined based on the way the material's electronic structure interacts with the incident light.

An aspect of the present disclosure provides a method for detecting a molecule, the method including the steps of introducing excitation light through the metalens to irradiate a sample and collecting fluorescence emitted from the sample through the metalens.

The metalens of the present disclosure may be used in epi-fluorescence detection, in which the light source for exciting the fluorophore and the sensor or detector for detecting the fluorescence signal share the same optical path and pass through the sample. The metalens of the present disclosure focuses the excitation light onto the sample while simultaneously collecting the fluorescence light emitted from the sample. Since the excitation light and the fluorescence light generally have different wavelengths, a dichroic mirror (or beam splitter) may be used to separate the two and detect the fluorescence.

In the molecular detection method according to ane embodiment of the present disclosure, the excitation light includes two or more different wavelengths, and the metalens performs the same phase correction function for each of the wavelengths.

The molecular detection method of the present disclosure shares the characteristics of the above-described metalens in that it utilizes the metalens, and redundant descriptions are omitted to avoid unnecessary complexity of the specification.

The features and advantages of the present disclosure may be summarized as follows:

(a) The present disclosure provides a metalens including a substrate and a plurality of nanostructures having a square pillar shape, arranged at regular intervals along circumferential and radial directions on the substrate.

(b) The present disclosure provides a detection device for a fluorescent material or a molecule conjugated with a fluorescent material, the device including the above-described metalens.

(c) The present disclosure provides a method for detecting a molecule, the method including the steps of: introducing excitation light through the metalens to irradiate a sample; and collecting fluorescence emitted from the sample through the metalens.

(d) The metalens of the present disclosure enables implementation of fluorescence correlation spectroscopy (FCS) using a single Alexa 647 molecule within the focal volume, due to its high numerical aperture, high focusing efficiency, and dual-wavelength operation characteristics. In addition, the metalens allows real-time monitoring of individual fluorescent nanoparticle transitions and identification of hydrodynamic diameters ranging from a few nanometers to several hundred nanometers. This improvement in sensitivity can be applied to extend metalens technology into ultra-compact single-molecule sensors.

### BRIEF DESCRIPTION OF THE DRAWINGS

The above and other aspects, features and advantages of the present disclosure will be more apparent from the following detailed description taken in conjunction with the accompanying drawings, in which:

FIGS. 1(a), 1(b) and 1(c) illustrate a dual-wavelength metalens for single-molecule detection: FIG. 1(a) schematic of the proposed concept. The metalens focuses a 635 nm laser inside a fluorescent molecular solution and collects fluorescence at 670 nm; FIG. 1(b) fluorescence spectrum of an Alexa 647 molecule. The vertical lines mark the target wavelengths of the metalens corresponding to laser line and emission wavelength of Alexa 647; and FIG. 1(c) confocal time-resolved setup using the metalens. (SP: short-pass filter, λ/2: half-wave plate, DM: dichroic mirror, LP: long-pass filter, BP: band-pass filter, SPAD: single-photon avalanche diode);

FIGS. 2(a) and 2(b) show the refractive index and extinction coefficient analysis results for hydrogen-doped amorphous silicon of FIG. 2(a) and glass (SiO₂) of FIG. 2(b);

FIG. 3 shows: ideal phase maps for light at 635 nm (a) and 670 nm (b), respectively; the phase difference between the two ideal phase maps (c); matched phase maps for 635 nm (d) and 670 nm (e) wavelengths, respectively; and the phase difference between the two matched phase maps (f);

FIG. 4 illustrates the principle of the propagation phase. The metalens modulates the phase of incident light under identical polarization conditions. A phase variation between 0 and 2H is achieved due to discrepancy in a transmittance between the major and minor axes;

FIG. 5 shows the transmittance as a function of width (W) and length (L) for incident light at 635 nm (a) and as a function of W and L for incident light at 670 nm (b), the conversion efficiency for incident light at 635 nm as a function of W and L (c) and for incident light at 670 nm as a function of W and L (d), and the phase as a function of W and L for incident light at 670 nm (e) and the phase as a function of W and L for incident light at 670 nm (f);

FIG. 6 shows the metal-atom width and length data for achieving phase matching between the two wavelengths;

FIG. 7 shows the conversion efficiency for incident light at 635 nm (a) and 670 nm (b) and the transmittance for incident light at 635 nm (c) and 670 nm (d);

FIG. 8 shows the conversion efficiency under identical polarization conditions for incident light at 635 nm (a) and 670 nm (b), and under cross-polarization conditions for incident light at 635 nm (c) and 670 nm (d), with the average conversion efficiency found to be 0.6582 at 635 nm light in (c) and 0.6221 at 670 nm light in (d);

FIG. 9 shows the transmittance analysis results according to the height of the metalens;

FIG. 10 illustrates the metalens design, showing a bright-field optical microscope image of the fabricated metalens (a), scanning electron microscope (SEM) images of the metalens at the center and off-center positions, respectively (b and c), a schematic of the dual-wavelength metalens functionality (d) m with the overlap between the excitation and detection volumes minimizing the confocal effective volume and providing efficient light collection, and the analysis results of molecular detection efficiency as a function of lens NA and focusing efficiency (FE), wherein the molecular detection efficiency is represented in arbitrary units;

FIG. 11 illustrates a home-built optical transmission microscope for determination of metalens PSF at 635 nm and 670 nm wavelengths. (ML: metalens, OL: objective lens, TL: tube lens);

FIG. 12 illustrates focal characterization of the metalens, presenting the lateral intensity profile results of the metalens at 635 nm and 670 nm wavelengths, respectively (a and b), the corresponding horizontal cuts of (a) and (b) (c), and the axial intensity profiles at 635 nm (left panel) and 670 nm (right panel) (d), with scanning measurements in the z-direction being carried out at 1-μm intervals;

FIG. 13 shows the two-dimensional intensity distribution at the focal plane for incident light at 635 nm (a) and 670 nm (b) and presents line distributions in the focal plane center (c) and d) scanning results in the z-direction;

FIG. 14 shows the results of single-molecule fluorescence detection using the metalens: (a) presenting fluorescence intensity time traces acquired at different concentrations of Alexa 647 in phosphate-buffered saline (PBS) (a); (b) shows the autocorrelation functions retrieved from selected time traces in (a). The autocorrelation functions at 1 nM and 6 nM were multiplied by three for clarity; (c) presents the number of molecules in the metalens detection volume retrieved directly from FCS correlation functions and background intensity data. Error bars represent standard deviations from FCS measurements; (d) shows normalized FCS autocorrelation functions of Alexa 647 in the presence and absence of glycerol. The diffusion time in 60 v/v % glycerol solution increased approximately 14-fold due to increased viscosity; and (e) presents fluorescence decay data of Alexa 647 in the presence and absence of 60 v/v % glycerol;

FIG. 15 shows the dependency of collected fluorescence intensity of Alexa 647 on laser power sent toward metalens (a) and the dependency of collected fluorescence intensity of nanoparticles (diameter: 490 nm) on laser power delivered through the metalens (b);

FIG. 16(a) presents the FCS autocorrelation function of diffusing Alexa 647 molecules when the metalens is out of focus and (b) shows the FCS autocorrelation function of diffusing Alexa 647 molecules when the metalens is removed from the beam path. The signal acquisition time is the same as that in the FCS measurement shown in FIG. 13;

FIG. 17 shows the FCS autocorrelation function of Alexa 647 (C=10 nM) in PBS excited using an objective lens (NA=1.2) (a) and in 60 v/v % glycerol excited using an objective lens (NA=1.2) (b), and shows the single-molecule brightness of Alexa 647 in PBS as a function of incident laser power (c);

FIGS. 18 (a) and (b) show the FCS autocorrelation functions of diffusing Alexa 647 molecules acquired using aspheric lenses with NA=0.18 and NA=0.54, respectively and (c), (d), (e), (f), (g), (h), and (i) show the FCS autocorrelation functions of diffusing Alexa 647 molecules acquired using achromatic objective lenses with NA=0.15, 0.25, 0.3, 0.5, 0.8, 0.95, and 1.25, respectively. The concentration of Alexa 647 was fixed at 6 nM for these measurements;

FIG. 19 shows a performance comparison of the metalens and conventional optical lenses: (a) illustrates the lens set used for the comparison study with indicated dimensional sizes: the metalens, two single-element aspheric lenses with NA=0.18 and 0.54, and achromatic objective lenses with NA ranging from 0.15 to 1.2; and (b) shows the Alexa 647 single-molecule brightness (CRM) detected by the metalens and aspheric lenses. The single-molecule brightness is considered zero for aspheric lenses since no FCS correlation was detected; (c) shows the Alexa 647 single-molecule brightness detected with the metalens and achromatic objective lenses; (d) shows the Alexa 647 diffusion time (td) detected with the metalens and achromatic objective lenses; and (e) shows the confocal effective volume (Veff) observed using the metalens and achromatic objective lenses;

FIG. 20 shows results of single nanoparticle detection and size identification: (a) presents normalized FCS autocorrelation functions of Alexa 647, quantum dots (QDs), and organic dye-coated plastic nanoparticles (NPs). Alexa 647 was excited with 1 mW laser power whereas QDs and NPs were excited with 100 μW; (b) shows the retrieved diffusion time (d) of emitters as a function of their hydrodynamic diameter (Dh). The black line corresponds to a linear fit following the Stokes-Einstein diffusion law; (c) presents the single Alexa 647 molecules and brightness values of nanoparticles (CRM) retrieved from FCS analysis; and (d) shows the fluorescence decay results of the analyzed emitters. The black line corresponds to the fitted decay. Due to the long lifetime of QDs, the repetition rate of the laser pulses was set to 5 MHz;

FIG. 21(a) shows the fluorescence intensity time traces of quantum dots (QDs) at 800 pM; (b) shows fluorescence intensity time traces of 110 nm nanoparticles (NPs) at various dilutions from the stock concentration; (c) shows the fluorescence intensity time traces of 490 nm NPs at stock concentration; (d) presents the FCS correlation function of 110 nm NPs obtained from the time trace in (b); and (e) shows the number of NPs determined from the FCS analysis in (b;

FIG. 22(a) shows the real-time monitoring of 110 nm NPs when one particle is present in the detection volume; (b) shows the real-time tracking of 110 nm NPs when 0.2 particles are present in the detection volume; (c) shows the background fluorescence real-time monitoring in pure PBS buffer; (d) shows the real-time tracking of QDs when 1.3 particles are present in the detection volume; (e) shows the real-time tracking of QDs when 0.17 particles are present in the detection volume; (f) shows the real-time tracking of QDs in pure PBS buffer; (g) shows the time trace histograms from (a)-(c) and the number of data points above a selected threshold line (dotted line) in (d)-(f) for two NP concentrations; and (h) shows the time trace histograms from (d)-(f) and the number of data points above the threshold line (dotted line) for two QD concentrations;

FIGS. 23 to 25 respectively show a unit structure, a top view, and a side view of the metalens, respectively.

### DETAILED DESCRIPTION OF THE EXEMPLARY EMBODIMENTS

A better understanding of the present disclosure may be obtained from the following examples, which are set forth to illustrate, but are not to construed to limit, the scope of the present disclosure.

### EXAMPLES

### Examples 1: Materials and Methods

### 1-1. Metalens Fabrication and Characterization

The dual-wavelength metalens was fabricated using a high-resolution electron beam lithography (EBL) system on a glass substrate. First, a high-refractive-index a-Si:H was deposited with 600-nm thickness on the substrate by a plasma-enhanced chemical vapor deposition at a specific condition with gas flows of about 10 sccm for SiH₄ and 75 sccm for H₂. After spin coating and soft baking a photoresist (Microchem, 950 PMMA A2) on the a-Si:H deposited substrate, the EBL system (ELIONIX, ELS-7800) was used to draw an optimized metalens design, followed by a development process using a methyl isobutyl ketone/Isopropyl alcohol 1:3 solution. In order to define an etch mask, A 40-nm thick chromium (Cr) was deposited on the patterned photoresist by electron beam evaporation system (KVT, KVE-ENS4004) and then the patterned photoresist was completely removed by acetone, leaving only Cr masks on the substrate for a selective etching process of the a-Si:H layer. After the dry etching (DMS, silicon/metal hybrid etcher) removed residual a-Si:H area not protected by Cr masks, the final metalens was achieved by wet-etching of the remaining Cr masks using Cr etchant (CR-7). All scanning electron microscopy (SEM) images were obtained using a field-emission SEM system (HITACHI, Regulus 8100) with typical operating voltage of 5 kV. The focal spots of the metalens were characterized using a camera-based microscope. Lasers with working wavelengths of 635 and 670 nm were used to produce spatially overlapping beams of light that were then adjusted by two lenses with the fiber coupling system to make the incident beam Gaussian. Two dichroic mirrors were employed to propagate the three beams at normal incidence. The metalens focal spots were magnified using a scanning horizontal microscope with an objective lens (Olympus PLANFL 100×, NA 0.8), a tube lens (Thorlabs TTL180-A), and an sCMOS camera (PCO panda 4.2). The horizontal microscope was mounted on a motorized stage (Thorlabs DDS100) to measure the intensity of the light with 1-μm intervals.

1-2. Time-Resolved Confocal Microscope Equipped with Metalens

As an excitation source, a 635-nm picosecond laser (PicoQuant, LDH P-C-635) with a pulse width of approximately 120 ps was employed. The laser repetition rate and synchronization were driven by the laser driver (PicoQuant, Sepia PDL 828). The laser beam was spatially filtered to produce a quasi-Gaussian profile. The possible long-wavelength light emitted by the laser was filtered out using a short-pass filter (Thorlabs, FESH0650). A dichroic mirror (Semrock, FF649-Di01-25×36) split the excitation and fluorescence light. The laser power values in the text corresponded to the incident power on the dichroic mirror. The incident power was adjusted using a half-waveplate placed before the polarizing beam splitter. A doublet lens (f=200 mm, Thorlabs, AC254-200-AB) was used to adjust the size of the incident beam to the aperture of the metalens. The molecular fluorescence was excited and collected using dual-wavelength metalens mounted on a microscope body (Nikon Eclipse Ti2). The metalens and doublet lens were removed in conventional fluorescence correlation spectroscopy (FCS) control experiments, and the following lenses were employed: aspheric lenses (Thorlabs, AL2520-A; Thorlabs, C560TME) and objective lenses (Olympus MPlanFL N NA=0.15, 5×; Olympus Plan N NA=0.25, 10×; Olympus MPlanFL N NA=0.3, 10×; Olympus UPlanFL N NA=0.5, 20×; Olympus MPlanFL N NA=0.8, 50×; Nikon PLAN APO AD NA=0.95, 40×; Nikon Plan Apo VC, NA=1.2, 60×, WI). The fluorescent light passes through a long-pass filter (Semrock, BLP01-635R-25), tube lens (Thorlabs, TTL200-A), confocal pinhole, and band-pass filter (Semrock, FF01-679/41-25) and was focused on a single photon avalanche diode (MPD, PD-050-CTC). The pinhole size was 80 μm in the case of the metalens measurements and 50 μm in the case of the objective lens control experiments. TCSPC and FCS data were recorded using a time-resolved module (PicoQuant, Multiharp 150 4P) with time resolution of 5 ps.

The effective focal length of the metalens-doublet lens system was given by a relation of

$$1 / f = 1 / {f}_{meta} + 1 / {f}_{DL} - ( \frac{d}{{f}_{meta}} {f}_{DL} )$$

where fₘₑₜₐ=0.33 mm and f_{DL}=200 mm are the focal lengths of the metalens and doublet lens, respectively, and d is the distance between the metalens and doublet lens. The distance d was 190 mm, which defined the effective focal length of the metalens-doublet lens system as 6.45 mm. Given that the focal length of the microscope tube lens is 200 mm, the magnification of the resulting metalens is 31×. The beam waist ox found from the focal spot images (FIG. 11) was about 0.9 μm leading to approximately 57 μm spot diameter at the pinhole plane. Therefore, the confocal pinhole size was set to 80 μm.

### 1-3. Samples of Fluorescent Molecules and Nanoparticles

Alexa Fluor 647 NHS Ester powder (HPLC purity 98%) was purchased from ThermoFisher Scientific (1 mg, catalog number: A20006). Alexa Fluor 647 molecules were dissolved in a phosphate buffer solution from Merck (PBS, pH 7.4, sterile, catalog number: P5244), diluted to 10 μM concentration, and stored at 4° C. in the dark. Nanomolar and picomolar solutions were prepared shortly before the experiment to avoid unwanted nonspecific adhesion to tube walls. High-viscosity experiments were conducted in the presence of glycerol in aqueous solution. Glycerol was obtained from Sigma-Aldrich (spectrophotometric grade ≥99.5%; catalog number: 191612). Quantum dots with a core/shell structure (CdSe/ZnS) were purchased from ThermoFisher Scientific (Qdot 655 ITK carboxyl quantum dots). Fluorescent nanoparticles with diameters of 110 and 490 nm were purchased from ThermoFischer Scientific (TetraSpeck, Fluorescence Microsphere Sampler Kit). The solutions were placed on a glass slide with a thickness below 0.17 μm to ensure that the working distance of the metalens was sufficient to focus through it.

### 1-4. Fluorescence Time Trace Data Processing

Fluorescence intensity time traces, FCS correlation functions, and TCSPC histograms were processed using SymPhoTime 64 (PicoQuant). The FCS correlation functions retrieved from the metalens measurements are fitted using the 3D-Brownian diffusion model with the background noise contribution:

$$G ( τ ) = \frac{{( 1 - B / F )}^{2}}{N ( 1 + \frac{τ}{{τ}_{d}} ) \sqrt{1 + \frac{τ}{{κ}^{3} {τ}_{d}}}} \qquad ( 1 )$$

wherein, B denotes the background noise (including the uncorrelated out-of-focus fluorescence intensity), F is the total collected fluorescence intensity, N is the number of molecules or nanoparticles, τd is the diffusion time, and κ is the aspect ratio of the focal volume. The background noise B was measured by moving the focal volume of the metalens below the fluorescent solution. Based on the correlation amplitude at zero lag time, the number of molecules/nanoparticles was determined as N=(1−B/F)²/G(0). The single molecule/nanoparticle brightness was directly deduced from the FCS measurements as CRM=(F−B)/N, where F−B denotes the fluorescence intensity collected from the detection volume. The acquisition time for FCS measurements of quantum dots (QDs) and nanoparticles (NPs) was conducted within 200s, while the Alexa 647 fluorescence has been recorded for 600s to improve the SNR. The apparent detection volume of the metalens was determined as V=Nₘₒₗ/(N_{A}·C) with N_{A} being Avogadro's number, C being the molecule concentration. The confocal effective volume was determined from the point spread function data (FIG. 11) as follows: V_{eff}=(Π^{3/2})ωₓω_{y}ω_{z}=56 fl, wherein ω represents the corresponding beam waist.

As Alexa 647 molecules tend to exhibit microsecond blinking, the FCS data from control experiments with a high NA objective lens (NA=1.2) was fitted by the diffusion model with a triplet term as follows:

$$G ( τ ) = \frac{1 + \frac{T}{1 - T} {e}^{- τ / {τ}_{r}}}{N ( 1 + \frac{τ}{{τ}_{d}} ) \sqrt{1 + \frac{τ}{{κ}^{2} {τ}_{d}}}} \qquad ( 2 )$$

wherein, T represents the fraction of molecules in the dark (triplet) state, and τT represents the triplet state blinking time.

The fluorescence decays were fitted by exponential functions via an iterative reconvolution that took into account the instrument response function (IRF). FWHM of the instrument response function (IRF) amounted to 160 ps. This analysis was performed through iterative calculations of exponential functions based on the instrument response function (IRF). Mono-exponential approximation appropriately fitted all the decays except for QDs.

### Example 2: Design Principle of Dual-Wavelength Metalens

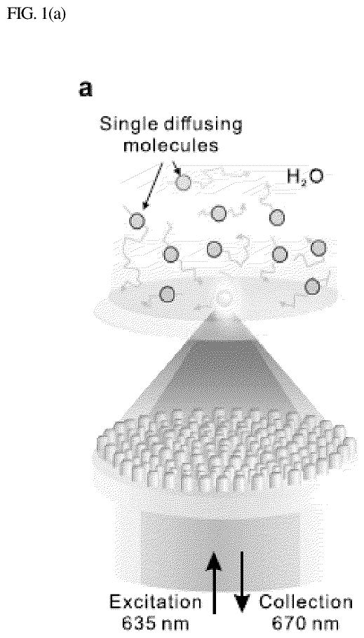

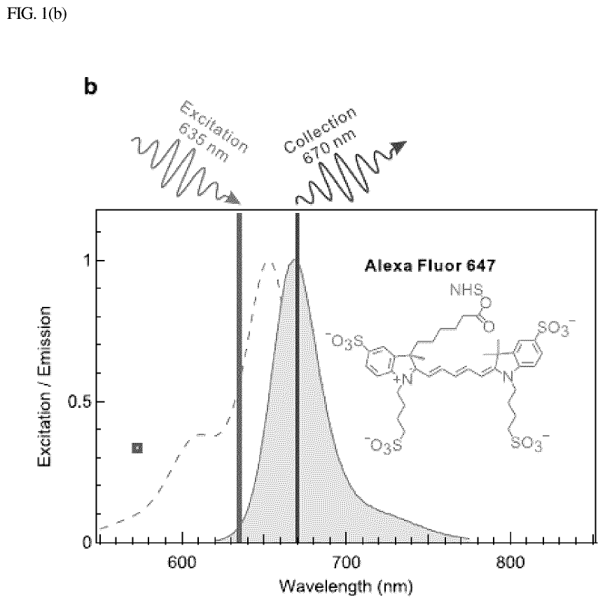

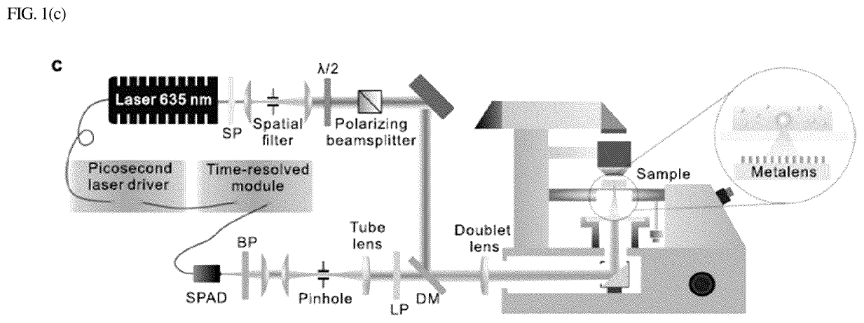

FIG. 1a shows the operational scheme of the metalens for the excitation and collection of the fluorescence of diffusing single Alexa Fluor 647 molecules. The two working wavelengths of 635 and 670 nm correspond to the laser line of our microscope and the emission maximum of Alexa 647 molecules (FIG. 1b). The rationale behind selecting these target wavelengths is to ensure efficient fluorescence collection from the laser spot and avoid excessive collection of out-of-focus uncorrelated background light. Single molecule spectroscopy experiments were conducted using a home-built time-resolved confocal epi-fluorescence microscope (FIG. 1c). The spectral filter set is optimized for fluorescence detection in the spectral band between 655 and 700 nm. The metalens focuses laser beam through a thin glass slide inside a fluorescent solution. The designed metalens device substitutes the excitation and collection objective lens on the microscope body.

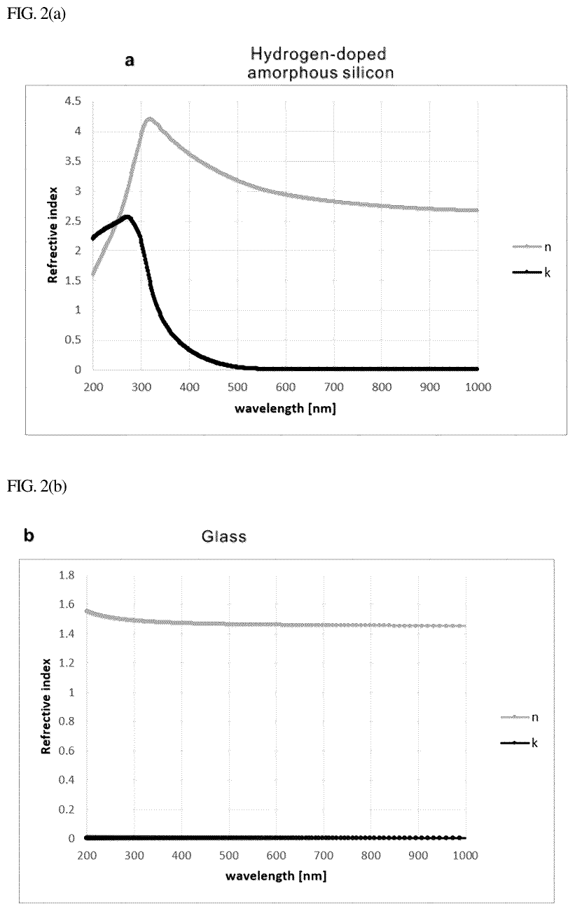

The metalens was composed of rectangular meta-atoms made of hydrogen-doped amorphous silicon (aSi:H) that exhibit a high refractive index and a low extinction coefficient at the working wavelengths (FIG. 2). The refractive index and extinction coefficient analysis values are summarized in the following Tables 1 and 2. The refractive index and extinction coefficient were measured using an ellipsometer.

TABLE 1
Refractive index and extinction coefficient analysis
of hydrogen-doped amorphous silicon(aSi:H)

| | Refractive | Extinction |
|---|---|---|
| Wavelength | Index(n) | Coefficient (k) |
| 200.54 nm | 1.58 | 2.1870 |
| 300.57 nm | 3.90 | 2.1646 |
| 400.70 nm | 3.61 | 0.3284 |
| 500.81 nm | 3.16 | 0.0369 |
| 600.75 nm | 2.92 | 0.0030 |
| 700.41 nm | 2.81 | 0.0006 |
| 801.23 nm | 2.73 | 0.0005 |

TABLE 2
Refractive index and extinction coefficient analysis of glass

| | Refractive | Extinction |
|---|---|---|
| Wavelength | Index(n) | Coefficient (k) |
| 200 nm | 1.55 | 0 |
| 300.35 nm | 1.49 | 0 |
| 399.73 nm | 1.47 | 0 |
| 502.52 nm | 1.46 | 0 |
| 602.82 nm | 1.46 | 0 |
| 697.78 nm | 1.46 | 0 |
| 798.40 nm | 1.45 | 0 |

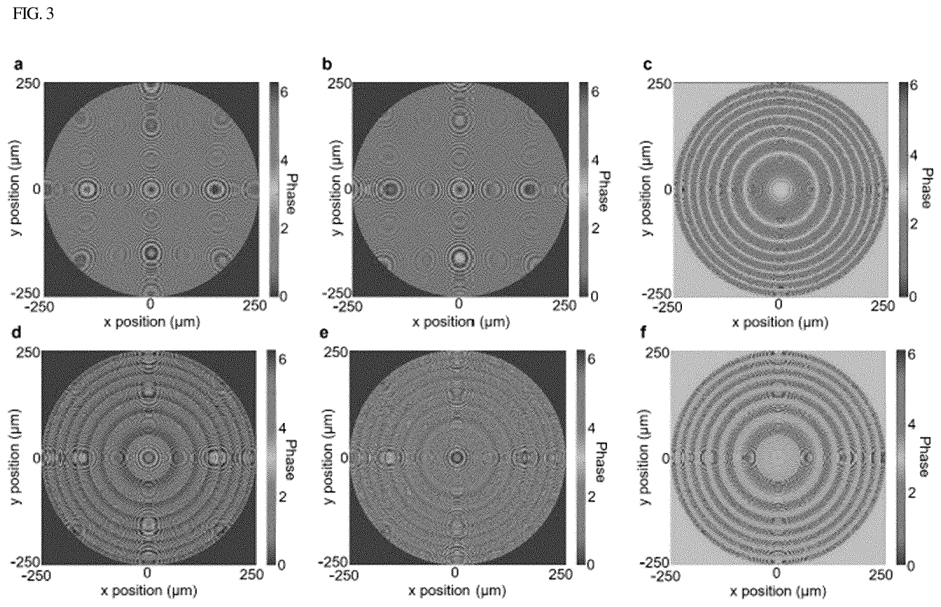

The diameter of the metalens is 500 μm, and the focal length (f) is 330 μm (NA=0.6). The metalens was designed to operate effectively at two wavelengths (635 nm and 670 nm), and the theoretical phase maps for this were calculated using the lens equation:

$$φ ( x , y ) = 2 π / λ \cdot ( f - \sqrt{{f}^{2} + {x}^{2} + {y}^{2}} )$$

where φ is phase, x and y are the spatial coordinates, respectively, and λ is the target wavelength (FIG. 3).

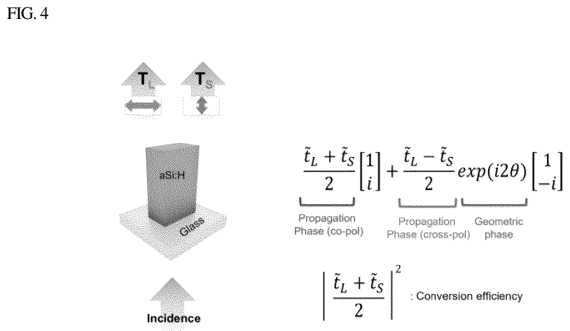

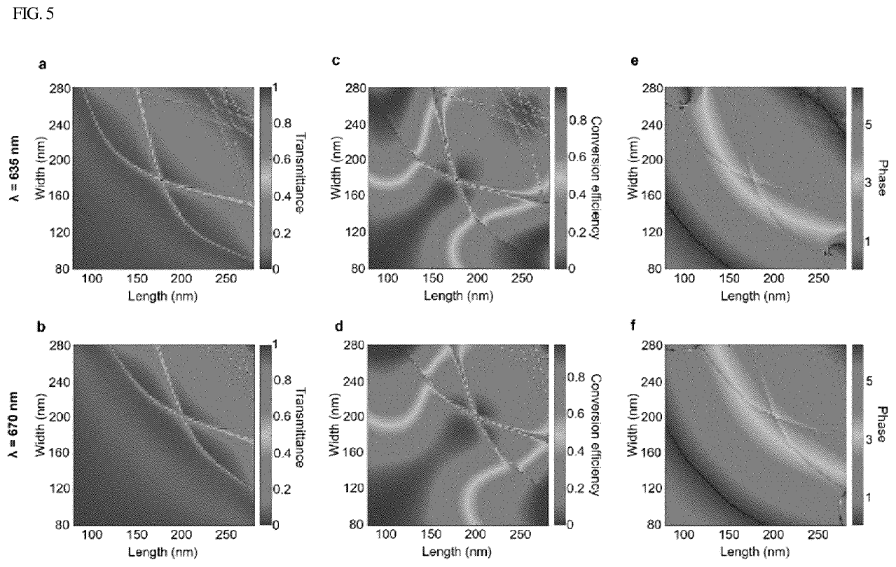

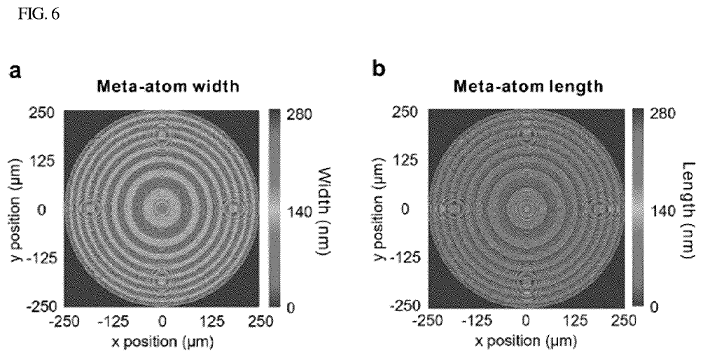

The metasurface modulates the phase of light in a specific polarization state (FIG. 4), which allows for focusing laser light and collecting fluorescence light. By exploiting the discrepancy in transmittance between the major and minor axes, it becomes possible to implement a phase variation ranging from 0 to 21. The researchers obtained the transmittance, conversion efficiency, and phase values of the meta-atoms through simulations by varying the width (W) and length (L) in 5-nanometer intervals within the range of 80 to 280 nanometers (FIG. 5). The meta-atoms included in the metalens had structural characteristics with a period (P) of 300 nanometers and a height (H) of 500 nanometers.

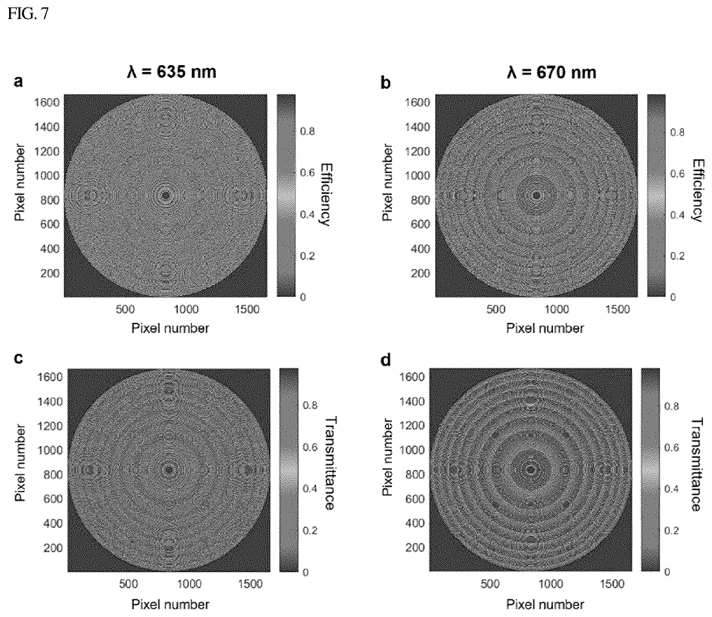

Based on the simulation results, selection was made of structures exhibiting transmittances above 50% and conversion efficiencies exceeding 50%. Among these structures, the present inventors identified the nanostructure geometry at each position that best approximated the theoretical ideal phase map for the incident wavelengths of 635 and 670 nm, achieving a matched phase map (FIG. 3). FIG. 5 shows the values of W and L for the nanostructures in the matched phase maps, respectively. The transmittance and conversion efficiency maps are shown in FIG. 6. Under the matching conditions, the average transmittance of the obtained metalens amounts to 82.6% at 635 nm and 83.5% at 670 nm, whereas the average conversion efficiency was 71.6% at 635 nm and 76.2% at 670 nm. This result represents the conversion efficiency obtained when using the co-polarization term, which is more than 5% higher than the conversion efficiency observed when using cross-polarization (FIG. 8).

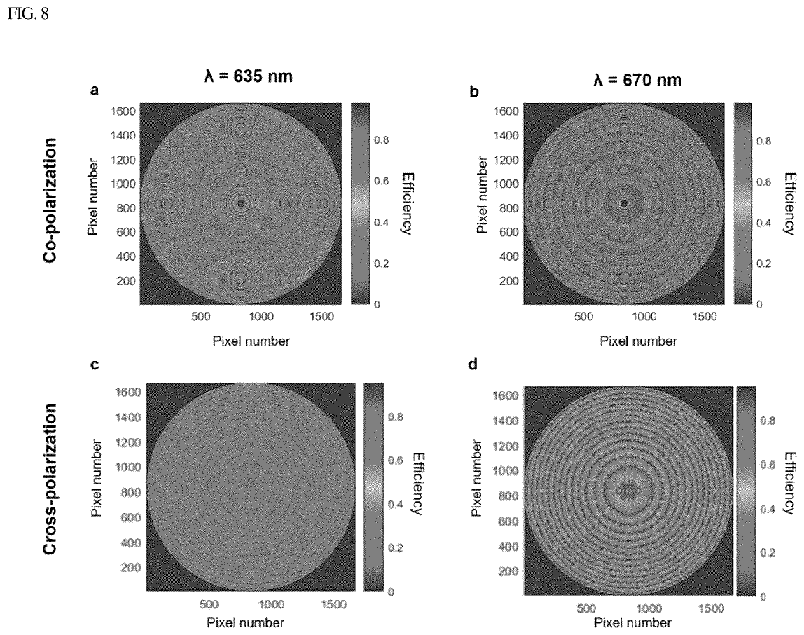

Based on the simulation results, nanostructures with a transmittance of 50% or more and a conversion efficiency exceeding 50% were selected. Among these, the nanostructure geometry that most closely approximated the theoretically ideal phase distributions for both incident wavelengths of 635 nm and 670 nm was identified to generate an appropriate phase profile (FIG. 3). FIG. 6 shows the width (W) and length (L) values of the nanostructures selected according to this matched phase profile. The results related to transmittance and conversion efficiency are shown in FIG. 7. The final metalens achieved an average transmittance of 82.6% at 635 nm and 83.5% at 670 nm. The average conversion efficiency was measured to be 71.6% at 635 nm and 76.2% at 670 nm. These results were obtained under co-polarized conditions and showed approximately 5% higher conversion efficiency compared to conditions using orthogonal polarization.

The relationship between the height of the nanostructures and the transmittance of the metalens was analyzed based on the average transmittance values for all widths and lengths of the nanostructures.

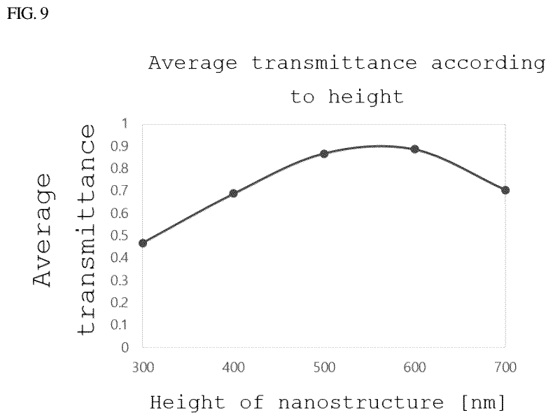

The results are shown in FIG. 9.

As shown in FIG. 9, the trend of transmittance change was reversed around a nanostructure height of approximately 600 nm, and the highest average transmittance was observed at a height of approximately 600 nm.

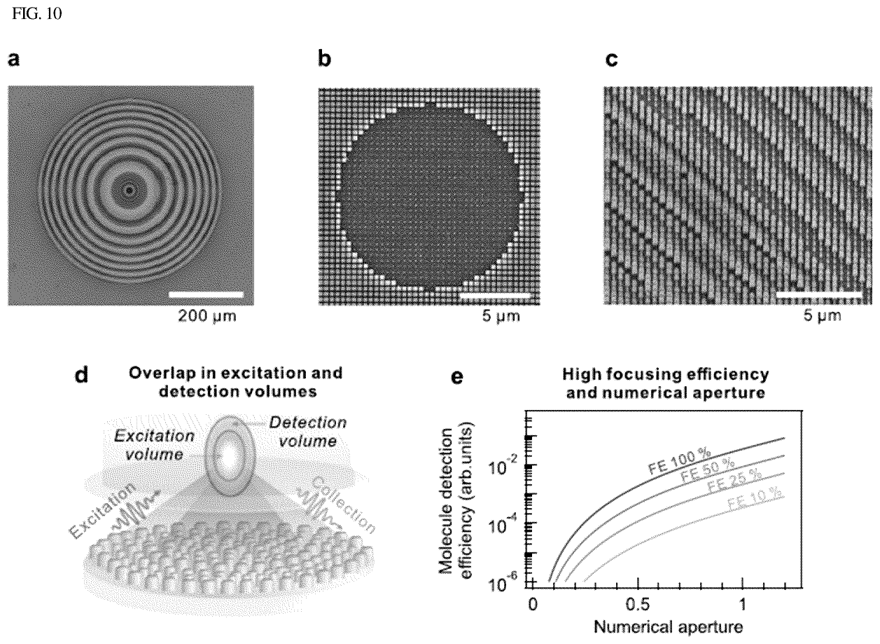

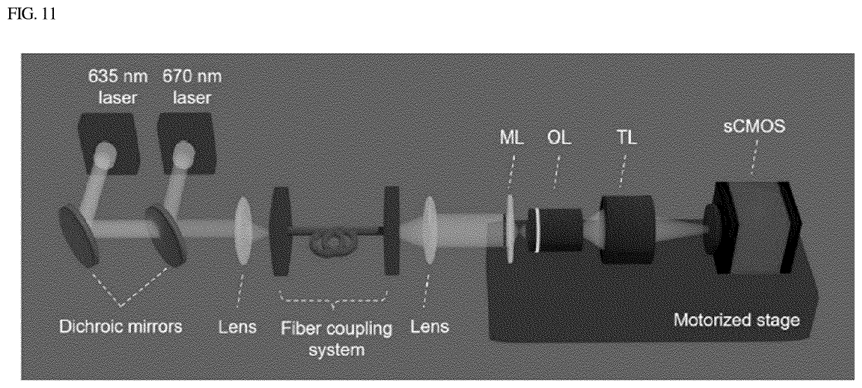

Next, the metalens is fabricated on a glass substrate using electron-beam lithography. A representative optical microscopy image of the metalens is shown in FIG. 10a. According to the scanning electron microscope (SEM) images, the fabricated metalens accommodates well-defined rectangular meta-atoms with sharp edges (FIGS. 10b and 10c). The rationale behind the optimization of focusing efficiency, NA, and chromatic aberration correction takes into consideration two main aspects: overlap of excitation and detection volumes (FIG. 10d) and molecule detection efficiency (MDE). The overlap mismatch of the excitation and detection volumes leads to the elongation of the FCS effective volume and limited single molecule brightness even for high NA lenses. MDE represents a metric of single molecule fluorescence intensity the system can detect and amounts to a product of the laser power density, i.e. the rate of pumping the molecules to their singlet excited state, and the collection efficiency of the system (CEF). Under the diffraction limit conditions, the laser power density is proportional to FE_{exc}·NA² wherein FE_{exc} is the metalens focusing efficiency (transmittance in case of conventional objective lens) at the laser wavelength. On the other hand, for a correctly set pinhole size, CEF is proportional to FEₑₘ(1−\sqrt{1−(NA/n)²}), where FEₑₘ is the metalens focusing efficiency (transmittance in case of conventional objective lens) at the emission wavelength, n is the refractive index of the aqueous solution. FIG. 10e displays the MDE plot as a function of NA at four exemplary metalens focusing efficiencies. Both NA and focusing efficiency drastically affect MDE, therefore, our rationale for a fabricable metalens design accommodates their trade-off together with dual-wavelength operation.

### Example 3: Evaluation of Focusing Performance

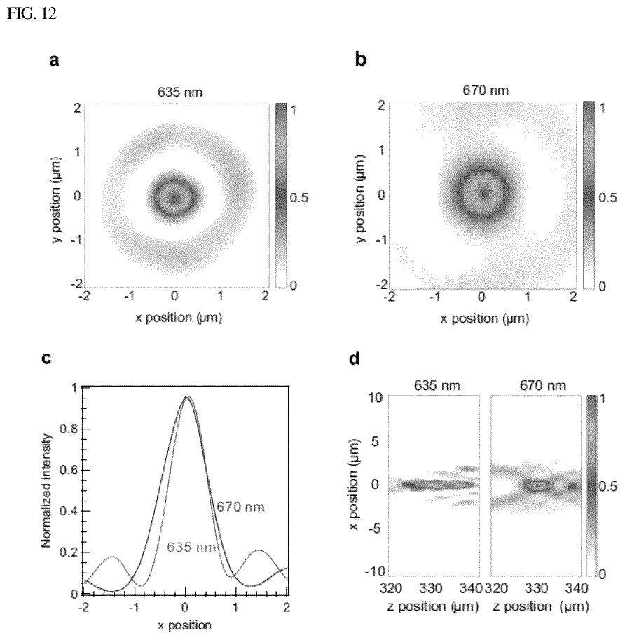

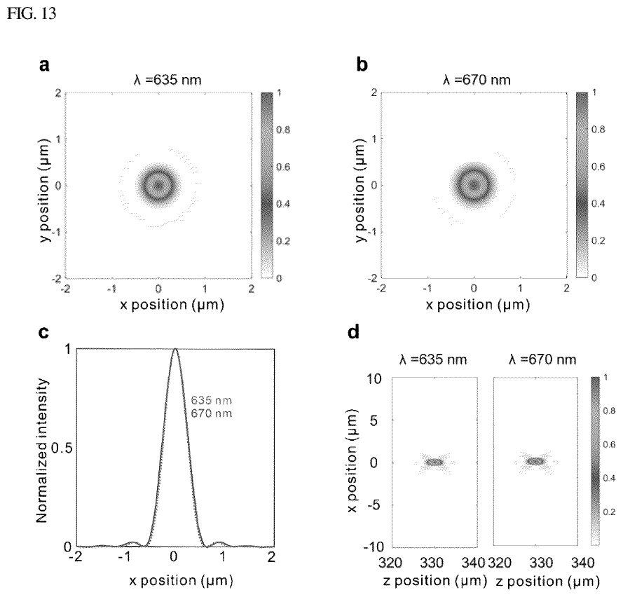

Focusing tests are conducted at the two target wavelengths to evaluate the performance of the fabricated metalens. The focal spots of the metalens are characterized using a transmission microscope (FIG. 11) with laser wavelengths of 635 and 670 nm. FIGS. 12 and 12b shows the resulting focal spot intensity images. The focal spots exhibit a highly circular shape (FIG. 12c) with a full width at half maximum (FWHM) of 0.77 μm at 635 nm and 1.03 μm at 670 nm. FIG. 12d represents the scanning results in the z-direction used to evaluate the depth of focus. The experimentally measured NA is the effective NA, which is determined by physical diameter and focal length. The images confirm that the focal points are positioned at a distance of 330 μm corresponding to effective NA=0.6, which is large enough to focus laser light through a thin glass slide. The focal distances match nearly perfectly, and the metalens focal volume aspect ratio is approximately 10. Herein, the focusing efficiency is defined as the ratio of the light intensity captured at the focal spot to the amount of incident light entering the metalens. At the incident wavelength of 635 nm, the focusing efficiency is measured to be 14.2%, whereas, at 670 nm, it increases to 37.1%. The higher focusing efficiency at 670 nm as compared with that at 635 nm is attributed to the shorter depth of focus. Compared with the case in which the theoretically ideal phase is applied (FIG. 13), the FWHM increases 1.35 and 1.89 times for the respective wavelengths. In addition, the depth of focus has increased, which can be attributed to two factors: (i) the challenge in achieving a perfectly identical phase with the matched phase approach and (ii) the difficulty in patterning nanostructures into perfect rectangular prisms owing to fabrication limitations. Nevertheless, the desired properties have not been achieved with single layer metalenses before, as the metalens performance comparison to achromatic lenses from prior arts was conducted (Table 3).

TABLE 3
Chromatic aberration correction, size, numerical aperture
(NA), and focusing efficiency of the metalens

| Working | | | | Focusing | |
|---|---|---|---|---|---|
| Wavelength | | Size | Effective | Efficiency | |
| (nm) | Feature | (μm) | NA | (%) | reference |
| 635/670 | Single layer | 500 | 0.6 | 14.1/37.1 | Inventive |
| 470 to | Achromatic; | 220 | 0.02 | ~20 | 1 |
| 670 | single layer | | | | |
| 465/578/ | Inverse | 115 | 0.3 | 42.8/42.4/38/33.3 | 2 |
| 600/620 | design, | | | | |
| | single layer | | | | |
| 1180/1400/ | Vertically | 120 | 0.29 | 34.5/30.7/51.1 | 3 |
| 1680 | stacked multi-layer | | | | |
| 488/532/ | Double layer | 1000 | 0.55/0.55/0.58 | 12.81/13.30/42.05 | 4 |
| 633 | | | | | |
| 1200 to | Achromatic; | 100 | 0.24 | ~35 | 5 |
| 1650 | single layer | | | | |

Reference 1: Chen, W. T. et al. A broadband achromatic metalens for focusing and imaging in the visible. Nature Nanotechnology 13, 220-226 (2018).
Reference 2: Jiang, Q. et al. Multiwavelength Achromatic Metalens in Visible by Inverse Design. Advanced Optical Materials 11, 2300077 (2023).
Reference 3: Zhou, Y. et al. Multilayer Noninteracting Dielectric Metasurfaces for Multiwavelength Metaoptics. Nano Lett. 18, 7529-7537 (2018).
Reference 4: Feng, W. et al. RGB achromatic metalens doublet for digital imaging. Nano Letters 22, 3969-3975 (2022).
Reference 5: Shrestha, S., Overvig, A. C., Lu, M., Stein, A. & Yu, N. Broadband achromatic dielectric metalenses. Light: Science & Applications 7, 85 (2018).

As creating multilayer metalenses with several layers is typically accompanied by layer alignment issues, the advantage of the metalens design of this work is implementation of single layer metalens with tight focusing and sufficiently high focusing efficiency at the fluorophore emission wavelength.

### Example 4: Metalens FCS of Single Molecules

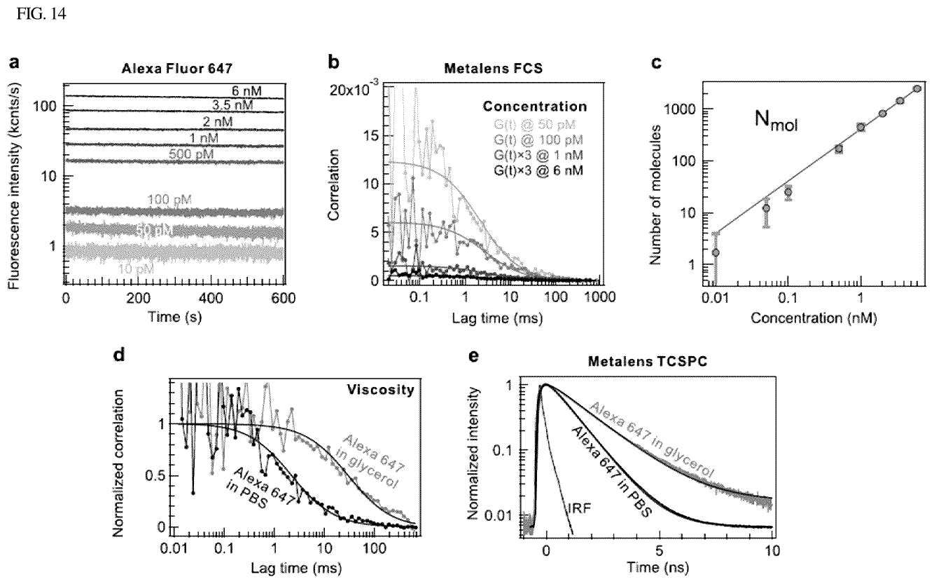

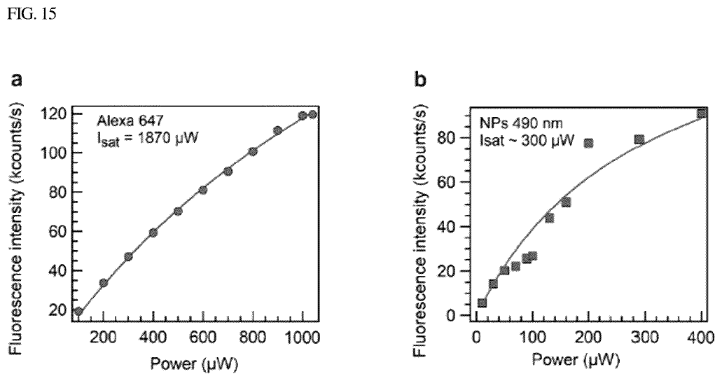

Afterward, the metalens is mounted onto a confocal epi-fluorescence microscope for single-molecule fluorescence sensing. An achromatic doublet lens was incorporated to adjust the beam width to the size of the metalens. The effective focal length of the metalens-doublet lens system defines the resulting ×31 magnification of the metalens microscope. Considering the metalens point spread function (PSF) data and magnification, an 80 μm confocal pinhole was employed. The fluorescence intensity time traces of the diffusing Alexa 647 molecules in a phosphate buffer solution (PBS, pH 7.4) were conducted (FIG. 14a). The laser power (1 mW) was below the fluorescence saturation intensity of the molecules (FIG. 15). The time traces were acquired at concentrations from 6 nM to 10 μM for approximately 10 min to accumulate a sufficient amount of single molecule events and reduce the FCS correlation function noise. The time traces were filtered using a post-processing time-gating technique, in a 10 ns fluorescence decay window. Time-gating filtering minimized the contribution of the long-lived metalens background noise.

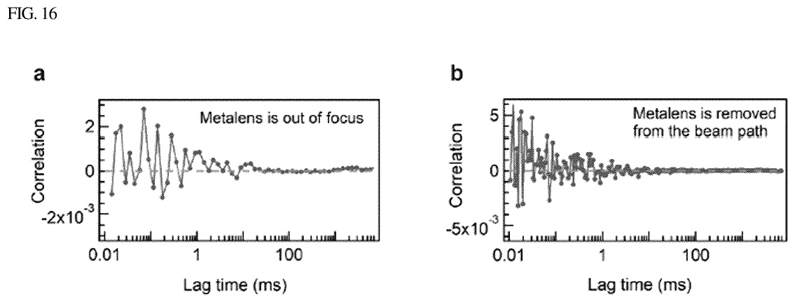

The single molecule sensitivity of the metalens system was determined by testing the possibility of recording the FCS correlation functions of the correct amplitude and decay time validates. It was confirmed that the correlation was zero if the metalens was defocused from the fluorescent molecule solution or completely removed from the light path (FIG. 16). Furthermore, the correlation amplitudes were observed to increase as the number of molecules decreases (FIG. 14b). The present inventors fitted the FCS correlation functions by the 3D-Brownian diffusion model with the fixed beam aspect ratio κ=10 and extracted the relevant parameters such as molecule diffusion time, number of molecules in the confocal effective volume of the metalens, single molecule brightness (CRM). The diffusion time through the metalens focal volume was measured at approximately 2.2 ms (Table 4).

TABLE 4
Metalens FCS fitting parameters of diffusing
Alexa 647 molecules/QDs/NPs

Fluores-

| cent | Concen- | | F | B | τd | | | CRM |
|---|---|---|---|---|---|---|---|---|
| object | tration | | (kHz) | (kHz) | (ms) | 1/G(0) | Nmol | (Hz) |
| Alexa 647 | 6 | nM | 134.6 | 47.3 | 3.5 | 5861 | 2465 | 36 |
| | 3.5 | nM | 83.6 | 34.7 | 3.5 | 4197 | 1435 | 34 |
| | 2 | nM | 45.1 | 18.2 | 2.7 | 2295 | 816 | 33 |
| | 1 | nM | 23 | 11.9 | 2.9 | 1949 | 445 | 26 |
| | 500 | pM | 16.2 | 10.6 | 3.6 | 1436 | 172 | 33 |
| | 100 | pM | 2.9 | 1.77 | 2.7 | 165 | 25 | 45 |
| | 50 | pM | 1.42 | 0.87 | 2.2 | 81 | 12.2 | 45 |
| | 10 | pM | 0.72 | 0.63 | 2 | 107 | 1.7 | 53 |
| QDs | 800 | pM | 21.2 | 3.31 | 20 | 297 | 211 | 85 |

| | | | | | | | |
|---|---|---|---|---|---|---|---|
| NPs 110 | C = C_{stock} | 110.4 | 13.5 | 147 | 326 | 251 | 386 |
| nm | | | | | | | |
| NPs 490 | C = C_{stock} | 14.6 | 3 | 730 | 2.2 | 1.3 | 8550 |
| nm | | | | | | | |

The dark-state blinking term with a characteristic time of 5 μs for Alexa 647 was not resolved because of the lack of single molecule brightness. Therefore, considering the standard diffusion model, analysis was made of the autocorrelation functions with lag times above 10 μs. The collected non-diffracted fluorescence light which is emitted away from the focal volume affects the correlation amplitude at high concentrations. In contrast, the residual background noise of the metalens structure restrains the correlation amplitude to below approximately 15×10⁻³ at low concentrations. To correctly identify the number of molecules, account was taken of the background intensity, i.e., the signal acquired when the metalens focuses the laser light below the fluorescent solution reservoir. The time traces and FCS correlation functions can be recorded for only 1.7 molecules at 10 pM concentrations, consolidating the ultimate sensitivity of the designed metalens. The number of detected molecules scales linearly with the concentration (C) from one to several thousand molecules. The apparent FCS detection volume in the aqueous solution amounts to 280 fl which exceeds the confocal effective volume determined from the PSF data by around 5 times. This focal volume increase appeared to be attribute to the collection of a fraction of non-diffracted ballistic fluorescent photons by the metalens and focal spot aberrations induced by light propagation through glass slides and aqueous solutions. Moreover, remaining chromatic distortion can contribute to the effective volume expansion, as it has been clearly demonstrated on near-unity NA aspheric lenses. The present inventors directly retrieved the single molecule brightness by dividing the fluorescence intensity collected from the detection volume by the number of molecules, and the fluorescence intensity of a single molecule was measured to be approximately 50 counts/s.

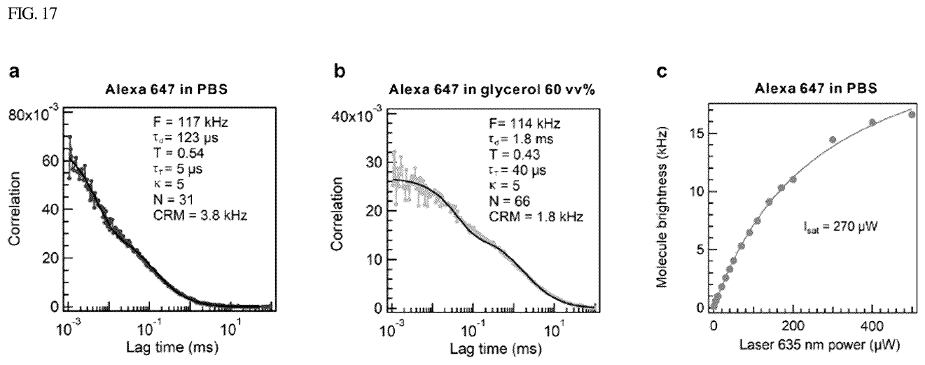

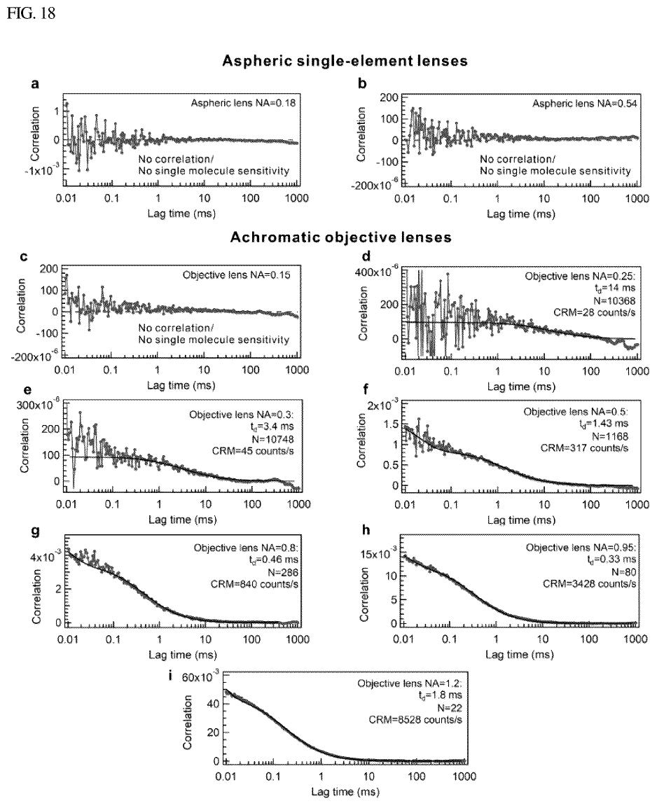

Next, the diffusion time of Alexa 647 molecules in a highly viscous solution (glycerol 60 vv % in PBS) was monitored. From the observed experimental (FIG. 14d), the diffusion time in glycerol increases by approximately 14 times, which is in good agreement with conventional objective lens measurements (FIG. 17). FIG. 14e shows the fluorescence decays of Alexa 647 determined by time-correlated single photon counting (TCSPC). Alexa 647 yields natural lifetime values of 0.97 ns without glycerol (Table 5).

TABLE 5
Metalens TCSPC histogram fitting parameters

| | τ1 | τ2 | | | τav |
|---|---|---|---|---|---|
| Emitting object | (ns) | (ns) | I1 | I2 | (ns) |
| Alexa 647 in PBS | 0.97 | | 1 | | 0.97 |
| Alexa 647 in | 1.57 | | 1 | | 1.57 |
| glycerol 60 v/v % | | | | | |
| QDs | 6.5 | 31.9 | 0.1 | 0.9 | 29.5 |
| NPs 110 nm | 4.63 | | 1 | | 4.63 |
| NPs 490 nm | 3.47 | | 1 | | 3.47 |

The mono-exponential decay and lifetime value agree with the expected Alexa 647 photophysical properties. The Alexa 647 lifetime, which is sensitive to the glycerol environment increases to 1.57 ns in the glycerol solution.

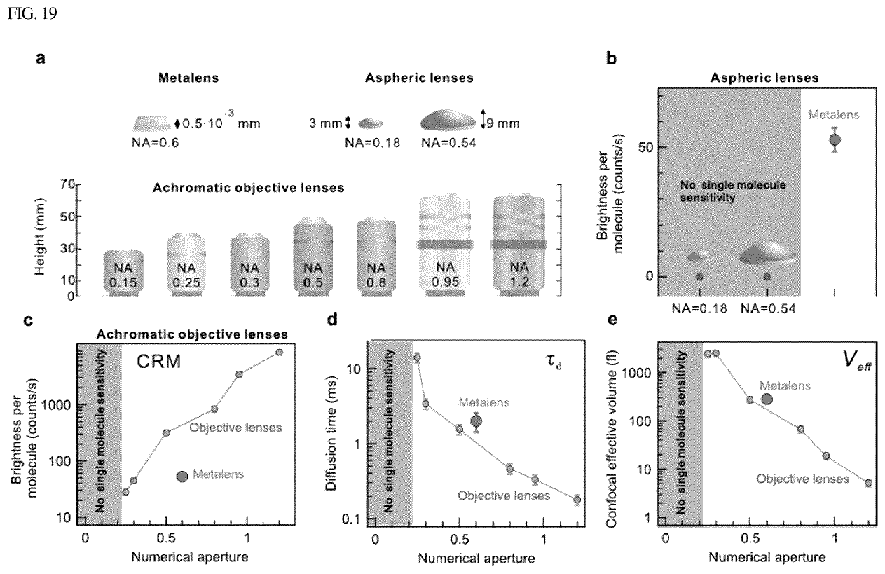

In order to provide an adequate comparison between our metalens performance and the conventional optics, FCS data of diffusing Alexa 647 molecules by a set of lenses of different NA and chromatic aberration presences was recorded (FIG. 19a). The fluorescence from Alexa 647 solution was excited and collected by two aspheric lenses of NA=0.18 and 0.54 and objective lenses of various NA in the range of 0.15 and 1.2.

TABLE 6
Size comparison between conventional
objective lenses and the metalens

| | Numerical | Height | Width |
|---|---|---|---|
| Lens type | aperture | (mm) | (mm) |
| Metalens | 0.6 | 0.5 · 10−3 | 0.5 |
| | | (structure) | |
| | | 0.5 (substrate) | |
| Aspheric | 0.181 | 3 | 7.5 |
| lenses | 0.54 | 9 | 25 |
| Achromatic | 0.15 | 30 | 25 |
| objective | 0.25 | 40 | 25 |
| lenses | 0.3 | 40 | 25 |
| | 0.5 | 50 | 25 |
| | 0.8 | 50 | 25 |
| | 0.95 | 65 | 33 |
| | 1.2 | 65 | 34.5 |

The corresponding raw FCS correlation traces are shown in FIG. 17. The present inventors observed that the aspheric lenses of NA close to that of the metalens or below fail to reach single molecule sensitivity under identical excitation/detection conditions (FIG. 19b). The lack of sensitivity comes from the mismatch in overlap between the excitation and detection single-element aspheric lens due to its intrinsic chromatic distortion. Employing achromatic multi-element objective lenses clearly boosts the single molecule fluorescence intensity, although it still remained undetectable for objective lenses with NA<0.25. The designed metalens exceeded the performance of objective lenses with NA<0.5 by all critical FCS parameters such as single molecule brightness, effective FCS volume, and diffusion time of molecules (FIGS. 19c to 19e). Although the metalens-enabled single molecule brightness and diffusion time fell short of those retrieved by NA=0.5 objective lens, the effective volume came close to the conventional objective lens trend.

Altogether, the metalens device proposed herein greatly miniaturized conventional objective lens size and maintained similar single molecule sensitivity. Moreover, the demonstrated dual-wavelength operation of the metalens encoded within a single nanostructure layer plays a pivotal role in providing sufficient collection efficiency from diffusing molecules, whereas conventional single-element refractive lenses typically strive to collect sufficient single molecule fluorescence signal even at high NA.

### Example 5: Size Identification and Real-Time Monitoring of Single Nanoparticles

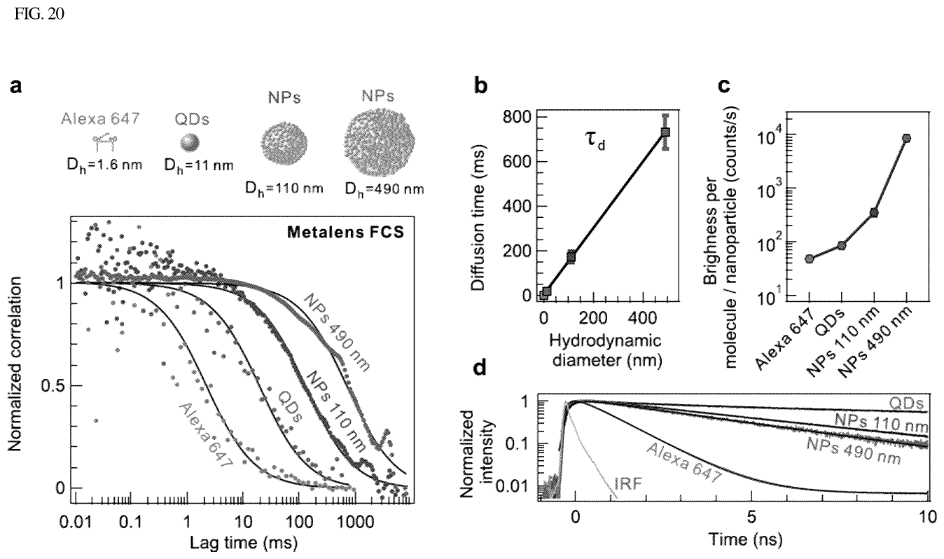

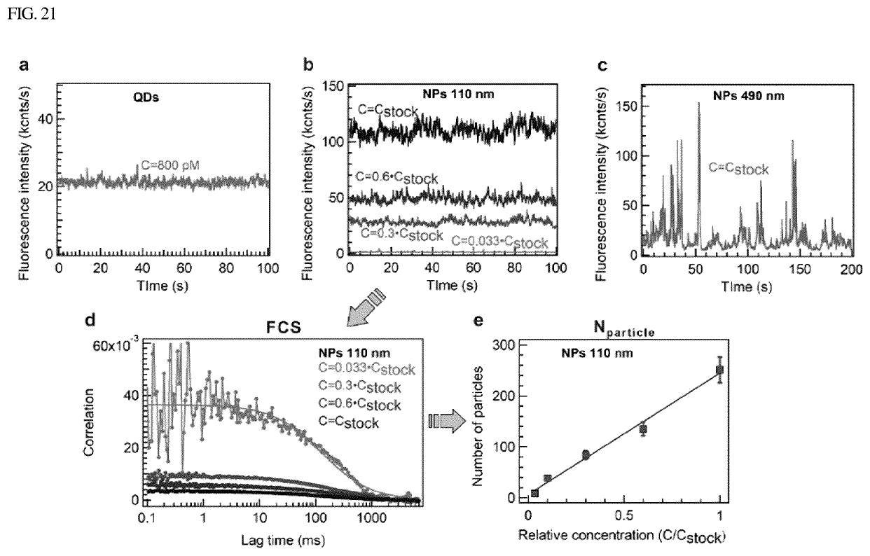

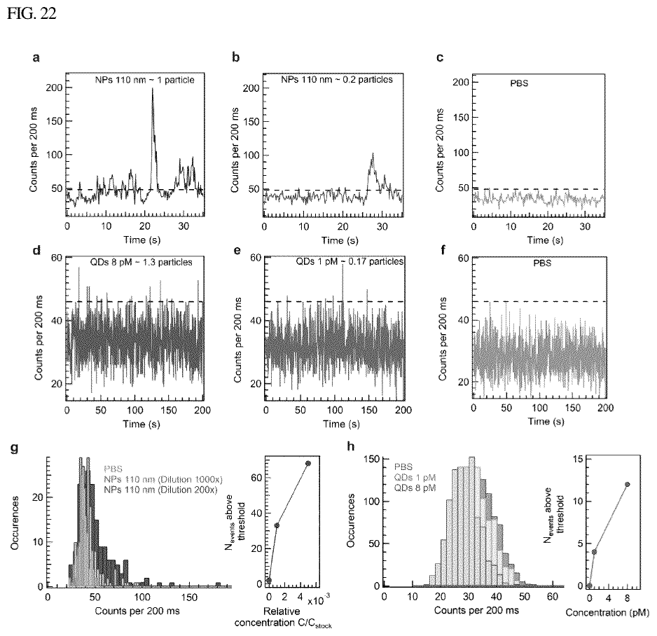

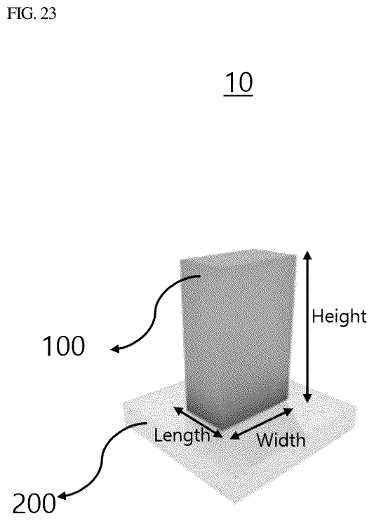

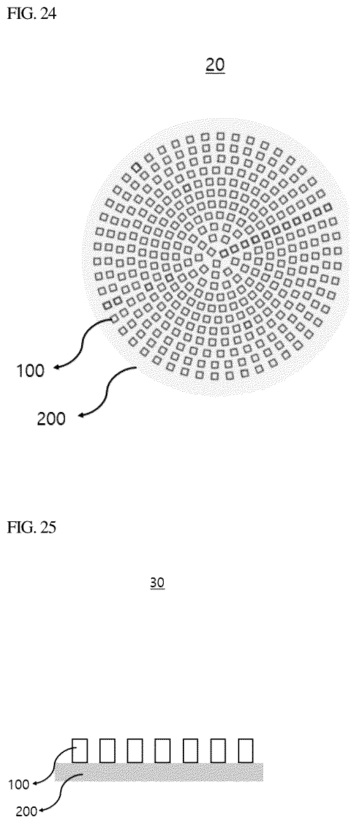

Single nanoparticle detection is important for environmental microplastic monitoring and biomedical viral tests. FCS allows us to extend the metalens applicability to the detection of different types of emitting single nanoparticles with the capability of size and concentration identification at nanometer precision. The present inventors performed FCS measurements on carboxyl quantum dots (QDs) with a hydrodynamic diameter (Dh) of 11 nm (emission maximum at 655 nm) and plastic nanoparticles with Dh=110 nm and Dh=490 nm, which are stained with dyes emitting at 680 nm (FIG. 20a). The excitation power is reduced to 100 μW to avoid photobleaching of the NPs (FIG. 15). The measured autocorrelation function demonstrates clear shifts toward longer emitter transit times as the hydrodynamic diameter of the nanoparticles increases. This size range lines up with nanoplastic size, i.e., microplastic below 1 μm that is released from ordinary environments. The metalens FCS can distinguish nanoparticle sizes far below the diffraction limit, where spatial analytical methods of microplastic are typically flawed. The determined number of nanoparticles follows in excellent agreement with the dilution of the colloidal solution (FIG. 21). The determined diffusion time increased linearly with the hydrodynamic diameter (FIG. 20b). Also, the brightness per nanoparticle increases with the size, following the increasing absorption of the nanoparticles (FIG. 20c). The nanoparticles with a size of 490 nm delivered bright and long fluorescent bursts of >10 kcounts/s. Furthermore, when the colloidal solution of nanoparticles was sufficiently diluted to make only one nanoparticle or less present in the detection volume (FIG. 22), the nanoparticle events produced bursts above the threshold value of the buffer solution. The time trace histograms feature tailed at higher count rates, even in the presence of approximately 0.17 nanoparticles, on average, which could correspond solely to single nanoparticle events. The fluorescence origin of the signal from the NPs is confirmed by fluorescence decay traces (FIG. 20d), with widths substantially exceeding the instrument response function (IRF).

The present inventors have experimentally demonstrated that a flat metalens device enables detection of single fluorescent molecules without any objective lens. The epi-fluorescence operation for allowed simplifying and miniaturizing the metalens microscope apparatus. These results confirm that the metalens platform can compete with complex and costly objective lenses for single molecule sensing and dynamics studies. Observing temporal signal fluctuations provided access to molecular parameters, such as the molecular diffusion coefficient and concentration, which could extend to molecular interaction dynamics and conformational rearrangements. Moreover, the present inventors recorded single diffusing nanoparticles in real time and unambiguously identified emitter hydrodynamic diameters ranging from one to hundreds of nanometers using the FCS approach. These results indicate that metalens have the potential to significantly downsize or replace expensive objectives with moderate numerical apertures. Further improvements in the performance of metalens could lead to single molecule sensitivity achieved by current technologies, and further provide additional functionality while achieving unprecedented control over optical properties.

### EXPLANATION OF REFERENCE NUMERALS

10: Unit cell of metalens
20: Plan view of metalens
30: Side view of metalens
100: Nanostructure
200: Substrate

What is claimed is:

1. A metalens, comprising: a substrate; and a plurality of nanostructures having a square pillar shape and arranged at regular intervals along circumferential and radial directions on the substrate.

2. The metalens of claim 1, wherein the metalens has a diameter of 100 to 1000 μm.

3. The metalens of claim 1, wherein the metalens has a height of 100 to 1000 nm.

4. The metalens of claim 1, wherein the metalens has a numerical aperture (N_{A}) of 0.5 to 2.0.

5. The metalens of claim 1, wherein the metalens has a property of modulating the phase of light such that a first light and a second light having different wavelengths exhibit the same phase shift upon transmission through the metalens, and a difference in wavelength between the first light and the second light is from 10 nm to 100 nm.

6. The metalens of claim 1, wherein the nanostructures having a square pillar shape have a length of 80 to 300 nm, a width of 80 to 300 nm, a height of 100 to 1000 nm, or a combination thereof.

7. The metalens of claim 1, wherein the nanostructures having a square pillar shape are arranged in a single layer.

8. The metalens of claim 1, wherein the nanostructures are arranged at intervals of 100 to 500 nm.

9. The metalens of claim 1, wherein the nanostructures is made of a material selected from the group consisting 41 hydrogenated amorphous silicon (a-Si:H), hydrogenated amorphous silicon nitride (a-SiNx: H), and hydrogenated amorphous silicon oxide (a-SiOx).

10. The metalens of claim 1, wherein the nanostructures have a refractive index (n) of 2.6 or more when transmitting light having a wavelength of 600 to 800 nm.

11. The metalens of claim 1, wherein the nanostructures have an extinction coefficient (k) of 0.1 or less when transmitting light having a wavelength of 600 to 800 nm.

12. The metalens of claim 1, wherein the nanostructures have a transmittance of 50% or more when transmitting light having a wavelength of 600 to 800 nm.

13. A detection device for a fluorescent material or a fluorescent material-conjugated molecule, comprising the metalens of claim 1.

14. The molecular detection device of claim 13, wherein the fluorescent material has a Stokes shift of 10 to 100 nm.

15. The molecular detection device of claim 13, wherein the fluorescent material is excited by light having a wavelength of 630 to 640 nm and emits fluorescence having a wavelength of 665 to 675 nm.

16. A method for detecting a molecule, comprising the steps of: introducing excitation light through the metalens of claim 1 to irradiate a sample; and collecting fluorescence emitted from the sample through the metalens.

17. The method of claim 16, wherein the excitation light includes two or more different wavelengths, and the metalens performs the same phase correction function for each of the wavelengths.
